(19) United States
(12) Patent Application Publication
(10) Pub. No.: US 2025/0009125 A1
(43) Pub. Date: Jan. 9, 2025

(54) AUTO-LOADING STORAGE SYSTEM

(71) Applicant: Paul Boardman, Sag Harbor, NY (US)

(72) Inventor: Paul Boardman, Sag Harbor, NY (US)

(21) Appl. No.: 18/765,530

(22) Filed: Jul. 8, 2024

Related U.S. Application Data
(60) Provisional application No. 63/525,479, filed on Jul. 7, 2023.

(51) Int. Cl. A47B 81/00; A47B 43/00; A47B 91/00; A47B 97/00; B60L 53/30; B60P 1/64; B60P 3/00; B65G 67/20

(52) U.S. Cl. CPC A47B 81/00; A47B 43/00; A47B 91/00; A47B 97/00; B65G 67/20; A47B 2220/0002; A47B 2220/0061; A47B 2220/0091; B60L 53/30; B60P 1/6427; B60P 3/007

(57) ABSTRACT

A unitized storage assembly for automated loading and unloading of an associated cargo space, including individual storage units that are positioned in rows, such that each row comprises an opposing pair of individual storage units and wherein each row is movably coupled to an adjacent row. The assembly further includes an elevating mechanism coupled to one of the individual units and operative to move the row vertically or horizontally relative to the adjacent row. The assembly includes a motor operatively coupled to a wheel rotatably mounted on a bottom surface of a base of one of the individual storage units. The assembly also includes a controller that activates the elevating mechanism to raise the pair of individual storage units a predetermined height, and the motor to rotate the wheel to move the unitized storage assembly in at least one direction.

### CROSS-REFERENCE TO RELATED APPLICATION

This application claims priority to U.S. Provisional Patent Application No. 63/525,479 filed on Jul. 7, 2023, entitled “AUTO-LOADING STORAGE SYSTEM” the entire disclosure of which is incorporated herein by reference.

### TECHNICAL FIELD

The present specification generally relates to storage assemblies, and, more specifically, to automated storage assemblies.

### BACKGROUND

Commercial enterprises often include distribution, processing, and/or delivery centers. Distribution centers are used to receive, process, and re-ship goods for subsequent transfer, delivery, or the like. When used in the delivery context, for example, distribution centers are tasked with loading one or more vehicles with packages or products to be delivered to retail or residential locations. The loading of the associated vehicle is typically a time-consuming process, requiring personnel to transfer box/packages from a loading dock into bins or onto shelves in the delivery vehicle. This process occurs after a picker (either person or robot) retrieves the items from a warehouse, packages the item (if needed), labels, and seals the package. Personnel must then organize the loading of the vehicle to ensure that the correct packages are loaded in a convenient manner (e.g., FIFO, LIFO, etc.) to minimize delivery times, fuel costs, employee time, etc. Similarly, loading other vehicles, shipping container, and/or railcars, for example, incur much of the same issues and time constraints.

Further, packages loaded onto trucks, containers, or other vehicles for delivery to a final or intermediate destination are generally not all the same size. As such, stacking and organization of the packages within the vehicle or container, while efficient for use of space, may cause delays and/or damage to packages when delivery is to be performed. For example, a driver may have to comb through multiple packages, move items out of the way, etc., in order to retrieve the correct package associated with a given delivery address. Attempts to overcome this have resulted in some of the above-identified time issues, i.e., extra personnel to check/recheck and manually load each item onto storage racks built into the backs of vehicles.

Therefore, a need exists for flexible unitized storage assembly adaptable for a variety of vehicles and containers that overcomes the aforementioned issues.

### SUMMARY

One aspect provides a unitized storage assembly for automated loading and unloading of an associated cargo space. The unitized storage assembly includes a plurality of individual storage units that are positioned in a plurality of rows, such that each row comprises an opposing pair of individual storage units and wherein each row is movably coupled to an adjacent row. The unitized storage assembly further includes an elevating mechanism coupled to at least one of the pair of individual storage units of one of the plurality of rows, the elevating mechanism operative to move the one of the plurality of rows in at least one of a vertical or horizontal direction relative to the adjacent row. Further, the unitized storage assembly includes a motor operatively coupled to at least one wheel rotatably mounted on a bottom surface of a base of at least one of the plurality of individual storage units. In addition, the unitized storage assembly further includes a controller in data communication with the elevating mechanism and the motor, the controller comprising a processor in communication memory storing instructions which are executed by the processor to activate the elevating mechanism to raise the at least one of the pair of individual storage units of one of the plurality of rows a predetermined height, and to activate the motor to rotate the at least one wheel to move the unitized storage assembly in at least one direction.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks.

The following description and the appended figures set forth certain features for purposes of illustration.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts a perspective view of a unitized storage assembly for automated loading and unloading according to one or more aspects shown and described herein;

FIG. 2 is a perspective view of an individual storage unit according to one or more aspects shown and described herein;

FIG. 3 is a side view of the unitized storage assembly in an associated vehicle in accordance with one or more aspects shown and described herein;

FIG. 4 is a top view of the unitized storage assembly in an associated vehicle in accordance with one or more aspects shown and described herein;

FIGS. 5A-5C are a variety of views of the unitized storage assembly in accordance with one or more aspects shown and described herein;

FIG. 6 is a close-in view of the wheels and motor of the unitized storage assembly in accordance with one or more aspects shown and described herein;

FIGS. 7-11 are a variety of views of an unloaded unitized storage assembly according to one or more aspects shown and described herein;

FIGS. 12-17 illustrating loading of an associated vehicle using the unitized storage assembly in accordance with one or more aspects shown and described herein;

FIGS. 18-19 are side view illustrations of varying loading configurations of the unitized storage assembly according to one or more aspects shown and described herein;

FIGS. 20-23 provide illustrative views of a unitized storage assembly loaded into an associated vehicle according to one or more aspects shown and described herein;

FIG. 24 depicts a controller according to one or more aspects shown and described herein;

FIG. 25 is a perspective view of a charging rail according to one or more aspects shown and described herein;

FIG. 26 is a front view of a charging mechanism according to one or more aspects shown and described herein;

FIG. 27 is an example implementation of a charging system according to one or more aspects shown and described herein; and

FIG. 28 is a rear view of a loaded vehicle according to one or more aspects shown and described herein.

### DETAILED DESCRIPTION

The present disclosure relates to unitized assemblies, storage systems and various components included as part of these systems and assemblies for enabling the automated loading of an associated vehicle. These unitized storage systems may also include input output interfaces, networking components, and controllers or computing systems that control operation of the various components of these systems. Moreover, these unitized storage systems and assemblies are both fixed and flexible in dimension, and the architecture of the overall systems/assemblies allows for mass customization thereof. The architecture further permits the use of assembled and disassembled configurations (e.g., through the use of universal posts described herein) which improve the shipping efficiency of these systems and assemblies. The present disclosure further generally relates to smart charging assemblies and various components included as part of these assemblies for enabling the charging of an associated vehicle.

It should be appreciated that while the various embodiments and aspects described herein relate particularly to automated loading/unloading structures, the present disclosure is not limited to such. That is, the various components, systems, and methods described herein can be implemented in other manners, such as other product delivery devices or systems.

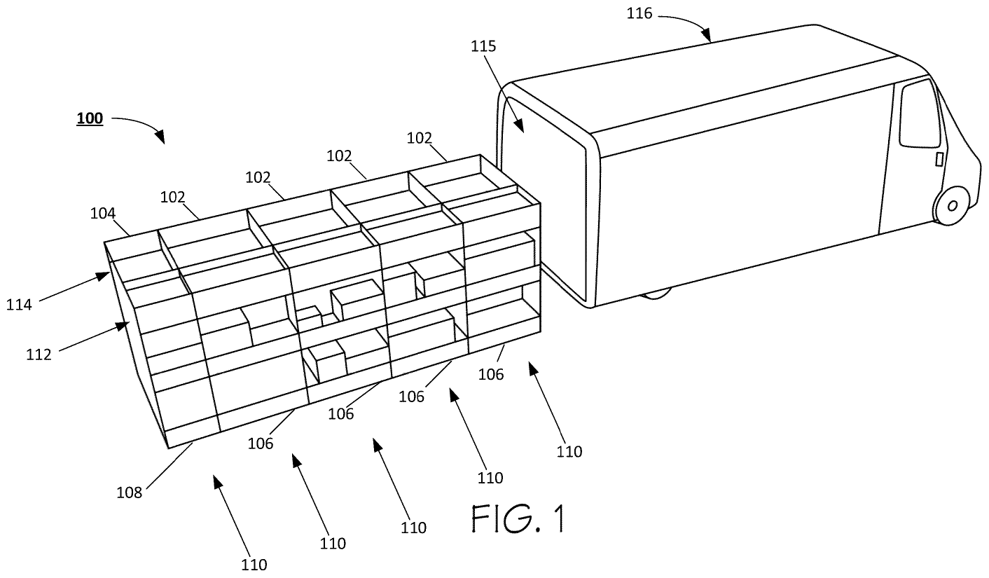

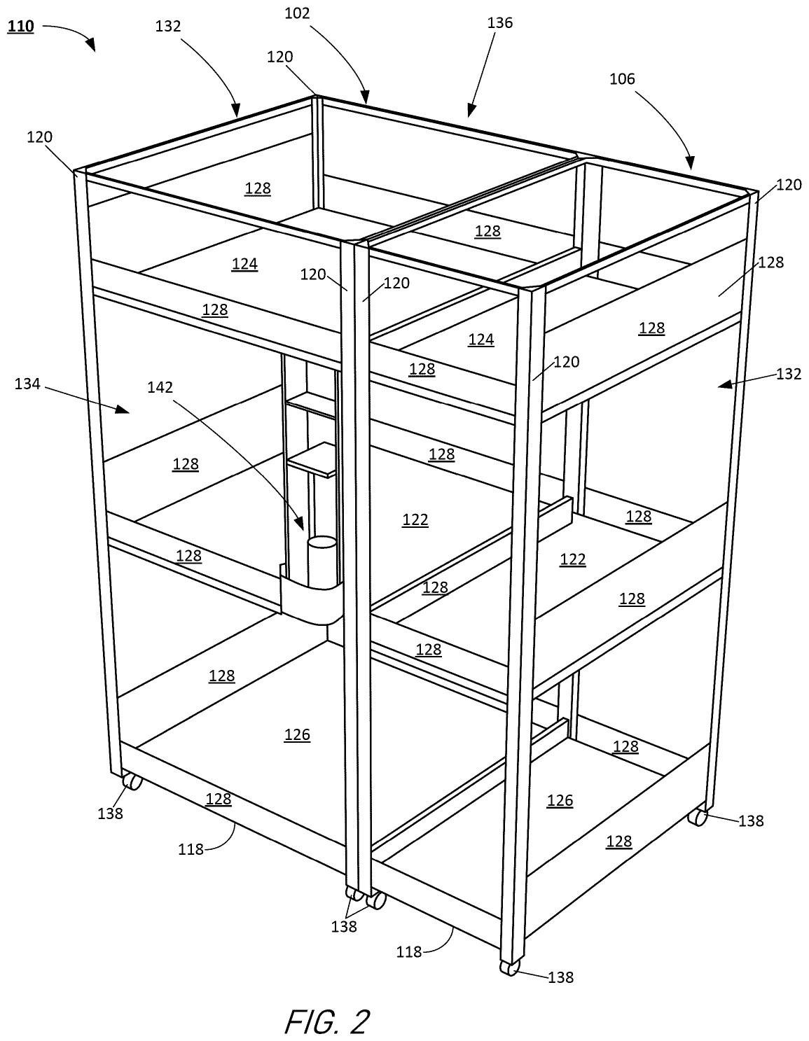

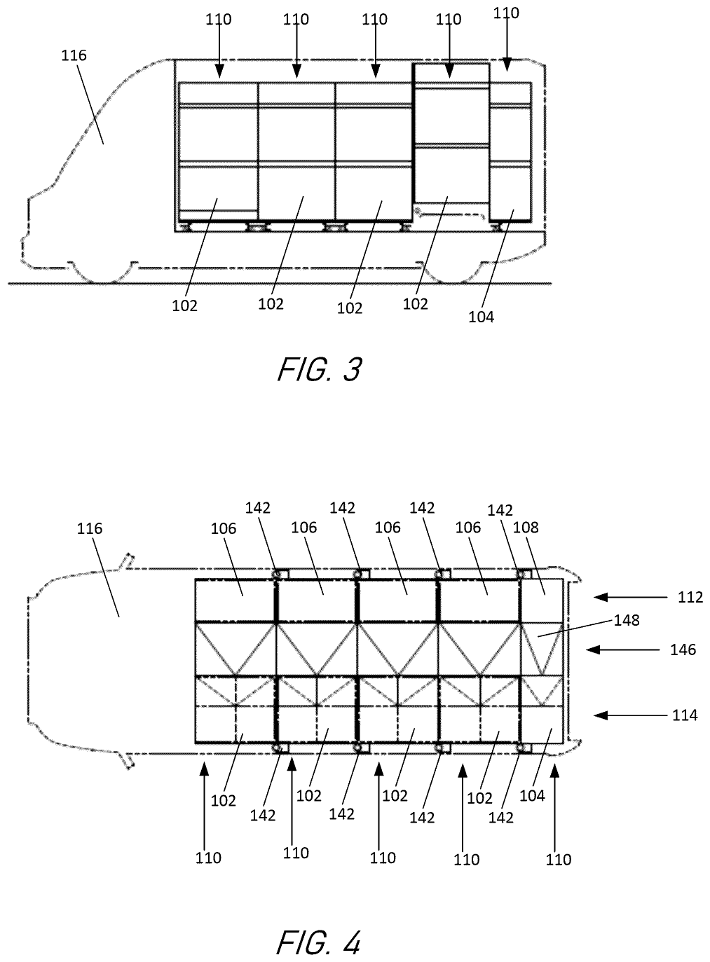

Turning now to FIG. 1, there is shown a three-dimensional view of a unitized storage assembly 100 in accordance with some aspects of the subject disclosure. As shown in FIG. 1, the unitized storage assembly 100 includes a plurality of various-sized individual storage units 102, 104, 106, 108. It will be appreciated that various combinations of storage units 102-108 may be utilized by a unitized storage assembly 100 in accordance with one or more aspects contemplated herein. As shown in FIG. 1, the unitized storage assembly 100 may be generally configured to be received within the cargo space of an associated vehicle. However, it will be appreciated that the associated vehicle can be virtually any size and/or type without departing from the scope of the present disclosure. For example, the associated vehicle may be a truck, van, passenger vehicles, heavy goods vehicle (HGV, box, etc.), electric vehicle (EV), EV quad vehicle, robotic vehicle, cargo plane, or sea cargo (short sea transport, e.g., barges, ferries, etc.), as well as shipping containers, railcar, etc. Sec, e.g., the side and top cut-away views shown in FIGS. 2 and 3 showing one example implementation of the unitized storage assembly 100 containing delivery cargo that is generally configured to be received within the cargo space 115 of the associated vehicle 116. Accordingly, it will be understood that the configuration of the unitized storage assembly 100 illustrated in FIG. 1 is intended solely as one non-limiting example, and other configurations are contemplated herein.

As shown in FIG. 1, the plurality of individual storage units 102-108 are generally positioned in a plurality of rows 110, wherein each row 110 comprises an opposing pair of storage units 102-108. The number of rows 110 of the unitized storage assembly 100, as will be appreciated, may be adapted in accordance with the size of the vehicle, trailer, container, etc., into which the unitized storage assembly 100 is inserted. The unitized storage assembly 100 may also be organized into a first column 112 comprising a set of adjacent storage units 102-108 and a second, opposing column 114 of a set of adjacent storage units 102-108, as shown in FIG. 1. Accordingly, FIG. 1 provides an illustration of an example implementation of five rows 110 configured to have a suitable width, height and length to fit into the associated vehicle, e.g., a delivery van. In such an example implementation, the individual storage units 102-108 of the unitized storage system 100 are shown arranged in a block configuration to utilize as much volume of the cargo space 115 as possible in the associated vehicle 116, while still maintaining enough room for a user to perform necessary tasks within the cargo space 115. Within such an example block configuration, individual storage units 102-108 are arranged in at least one column 112, 114 extending in the vehicle front-rear direction and at least one row 110 extending the in the vehicle width direction.

Each row 110 may be movably coupled to an adjacent row 110, allowing for vertical and/or horizontal movement of a row 110 relative to such adjacent row 110 in accordance with varying configurations disclosed herein. Such movable couplings may further be configured for detachment to reduce the number of rows 110 to accommodate additional configurations for smaller vehicle or containers. In some aspects, vertical movement of a row 110 relative to an adjacent row 110 may be accomplished via automated mechanisms, including, for example and without limitation, magnetic drives, chain drives, hydraulic drives, electric drives, or any suitable combination thereof.

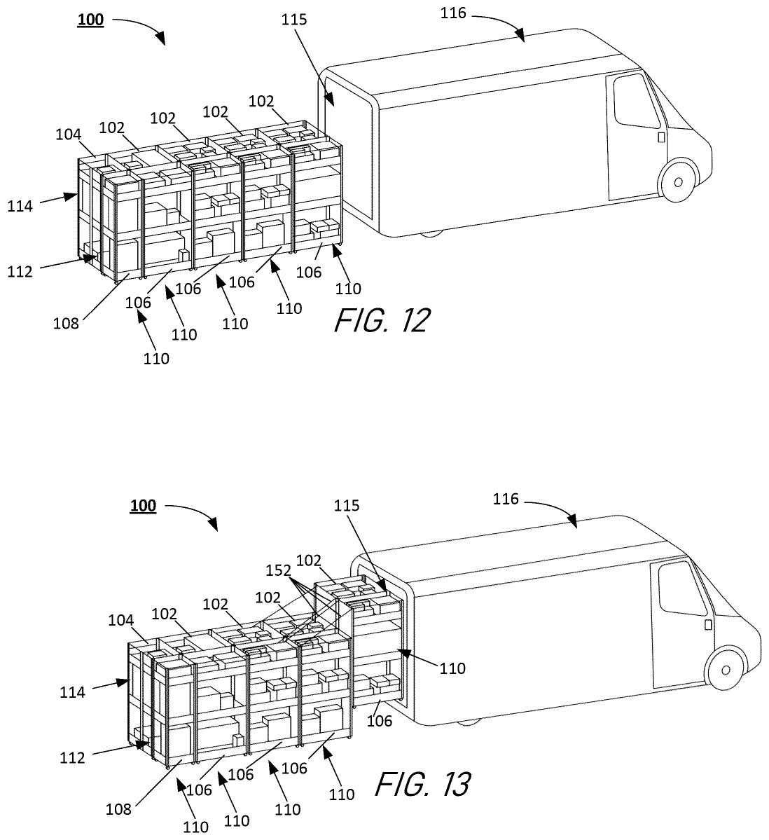

As briefly mentioned above, each storage unit 102-108 may be movably coupled to an adjacent storage unit 102-108. Such coupling may be implemented as universal joinery, universal posts, universal connections, etc. In some aspects, the aforementioned universal joinery may generally refer to a combination of universal split columns, drop column inserts, and rigid stacking studs, each of which may be integrally incorporated within the fabrication of the unitized storage assembly 100. The universal posts 120 may be constructed of varying materials, such as steel angle and channel framing, precast concrete slabs, heavy timber posts, steel angles, mass timber panels, steel tub columns with steel joists, wood framed panels to steel, stone faced panels to steel, chromed/black steel to steel mesh, and/or steel to pre-cast concrete panels. The drop column inserts may be implemented as rotating connection pins that allow for the simple assembly of the units and posts with other unitized systems and/or assembly joineries. The rigid stacking stud is a fixed column connection integral with the unitized storage system 100 providing system seismic resistance. The fixed positioning of the rigid stacking stud allows for connection to the universal post, and in combination with the drop column insert, enables a rigid column-slab connection. Further details regarding the movement of the adjacent storage units 102-108 are discussed with respect to FIGS. 12-17, below.

Turning now to FIG. 2, there is shown a single row 110 of storage unit 102 and storage unit 106 in accordance with some aspects contemplated herein. The left side storage unit 102 has a storage volume which is approximately double the storage volume of the right side storage unit 106. Thus, the right side storage unit 102 of FIG. 2 may be referred to as a full size storage unit and the left side storage unit 106 may be referred to as a half size storage unit. However, it should be understood that the different storage units 102-108 can have the same or different storage volumes without departing from the scope of the present disclosure. For example, a quarter size storage unit, e.g., the storage unit 108 shown in FIG. 1 may be included with half the storage volume of the half size storage unit 106.

Each storage unit 102-108 is generally defined by a base 118, one or more universal posts 120 extending vertically upward from the base 118, and one or more shelves 122, 124 horizontally supported by the one or more universal posts 120. An upper surface 126 of the base 118 is configured as a shelf for storing one or more packages thereon. As such, each storage unit 102-108 is illustrated in FIG. 1 as having three shelves 122-126 (i.e., the upper surface 126 of the base 118, the middle shelf 122, and the top shelf 124). However, more or less shelves 122-126 may be included in accordance with varying design requirements, height of the vehicle 116, container, trailer, etc. In accordance with some aspects contemplated herein, each shelf 122-126 may include one or more sidewalls 128 to help prevent packages stored thereon from falling off the storage unit 102-108.

As briefly discussed above, the storage units 102 and 106 shown in FIG. 2 includes four universal posts 120 extending vertically upward from each corner of respective bases 118 of the storage units 102 and 106. It will be appreciated that the illustration in FIG. 2 is intended solely as one non-limiting example arrangement and more or less universal posts 120 may be included and located elsewhere on the base without departing from the scope of the present disclosure. A face is defined between each universal post 120 of each storage unit 102-108. Thus, a front face 130 and an opposing rear face 132 extend parallel to the vehicle width direction, and an outer side face 134 and an opposing inner side face 136 extend parallel to the vehicle front-rear direction. When assembled into a row 110, the inner side faces 136 of each storage unit 102-108 are aligned and the two universal posts 120 which define the inner side face 136 of the full size storage unit 102 abut the two universal posts 120 which define the inner side face 136 of the half size storage unit 106.

In some embodiments, one or more engagement features may be provided on each inner side face 136 of each storage unit 102-108. The one or more engagement features may be disposed one of the base 118, universal posts 120, or shelves 122-126 of each storage unit 102-108. When the inner side faces 136 are aligned and abut together, the respective engagement features engage one another and lock the inner side faces 136 into alignment. Once engaged, the one or more engagement features help prevent the row 110 of storage units 102-108 from splitting, thereby helping to maintain the overall block configuration of the plurality of storage units 102-108 (as illustrated in FIG. 1).

In accordance with some aspects contemplated herein, at least one of the storage units in a row 110 of storage units is provided with at least one elevating mechanism 142 configured to raise an adjacent row 110 to a specified height. In some embodiments, the elevating mechanism is disposed on the rear face 134 of each storage unit 102-108 as illustrated in FIG. 2. In such an embodiment, the elevating mechanism 142 may be supported between the upper shelf 124 and middle shelf 122 of the storage unit 102-108. However, it is contemplated that the elevating mechanism 142 may be supported elsewhere, such as on one of the universal posts 120, for example. The elevating mechanism 142, being located on a first storage unit 102-108 or first row 110 of storage units 102-108, may engage a corresponding feature disposed on the front face 130 of an adjacent storage unit 102-108 or row 110 of storage units 102-108, such that upon activation of the elevating mechanism 142, the corresponding feature permits the elevating mechanism 142 to raise the first storage unit 102-108 or first row 110 of storage units 102-108 to a specified height.

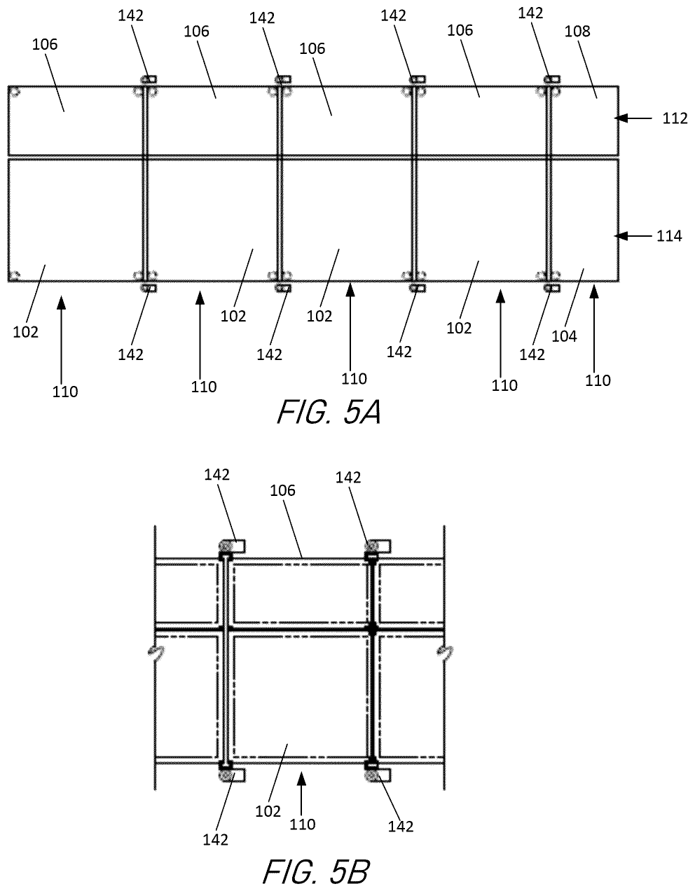

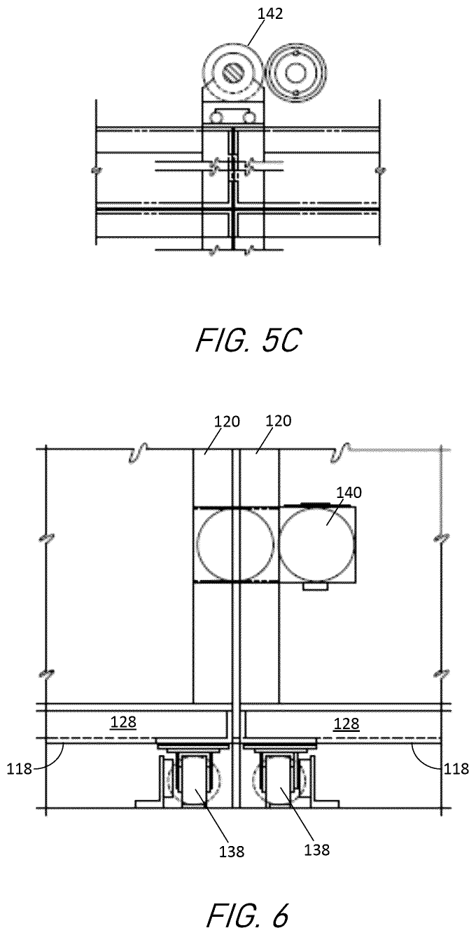

In accordance with another example aspect, the elevating mechanism 142 may be positioned adjacent to the front face 130 and disposed on the outer side face 134 of each storage unit 102-108 in a row 110. FIGS. 5A-5C provide a variety of views illustrating such an alternative location of the elevating mechanism 142 according to such aspects. As shown in FIGS. 5A-5C, the elevating mechanism 142 may be supported on at least one of the base, universal post 120, and/or shelf 122-126 of each storage unit 102-108.

As shown in FIGS. 5A-5C, a portion of the elevating mechanism 142 extends forward from the front face 130 of a first storage unit 102-108 such that the forward extending portion can engage with an adjacent storage unit 102-108. In this regard, the elevating mechanism 142 may include a carriage or bracket (not shown) connected between a rear side universal post 120 of the adjacent storage unit 102-108 and a front side universal post 120 of the first storage unit 102-108. The carriage moves vertically up and down with respect to the front side universal post 120 of the first storage unit 102-108 but is restricted from vertical movement with respect to the rear side universal post 120 of the adjacent storage unit 102-108. Thus, upon activation of the elevating mechanism 142, the carriage moves vertically upward along the front side universal post 120 of the first storage unit 102-108 and thereby lifts the adjacent storage unit 102-108 since movement along the rear side universal post 120 is restricted.

According to some aspects, the elevating mechanism 142 may be implemented as, for example and without limitation, a linear actuator, such as a hydraulic, pneumatic, mechanical (screw), or electro-mechanical linear actuator. Linear actuators may include, for example, a leadscrew, screw jack, ball screw, or roller screw-type actuator which provide vertical linear motion by rotating a nut to move a screw shaft. Linear actuators may also include, for example, a hoist, winch, rack and pinion, chain drive, belt drive, rigid chain, or rigid belt-type actuator which provide vertical linear motion by rotating a wheel to move a cable, rack, chain, or belt. In other embodiments, the elevating mechanism 142 is a scissor lift.

In accordance with some aspects contemplated herein, movement of the rows 110, individual units 102-108, the unitized storage assembly 100, etc., may be accomplished via one or more wheels, casters, or other means of linear propelled movement, hereinafter collectively referred to as wheels 138. As illustrated in the example of FIG. 6, the wheels 138 are affixed to a lower surface of the base 118 of each storage unit 102-108. At least one of the wheels 138 of each storage unit 102-108 may be powered by a motor 140, such as an axial motor, radial motor, brushless motor, linear motor, direct-drive motors, servo-motor, etc., for example. The motor 138 may be supported on the base 118, one of the universal posts 120, or one of the shelves 122-126 of the storage unit 102-108 and powers the at least one wheel 138 such that linear movement of the storage unit 102-108 can be controlled. Furthermore, the wheels 138 of each storage unit 102-108 may be rotatably attached to the lower surface of the base 118 such that the direction of linear movement can be changed as desired. In this regard, a separate motor (not shown) may be provided to radially adjust the position of the wheels 138 to provide for movement in different directions. The wheels 138 may initially be positioned to provide movement of the storage unit 102-108 in a direction parallel to the associated vehicle's front-rear direction during an automated loading process of the cargo space 115, as discussed in further detail below. The wheels 138 may then be rotated 90 degrees to provide movement of the storage unit 102-108 in a direction parallel to the associated vehicle's width direction, such as during an automated separation process to create an aisle 146 between the columns 112-114 of the storage units 102-108, as discussed in further detail below.

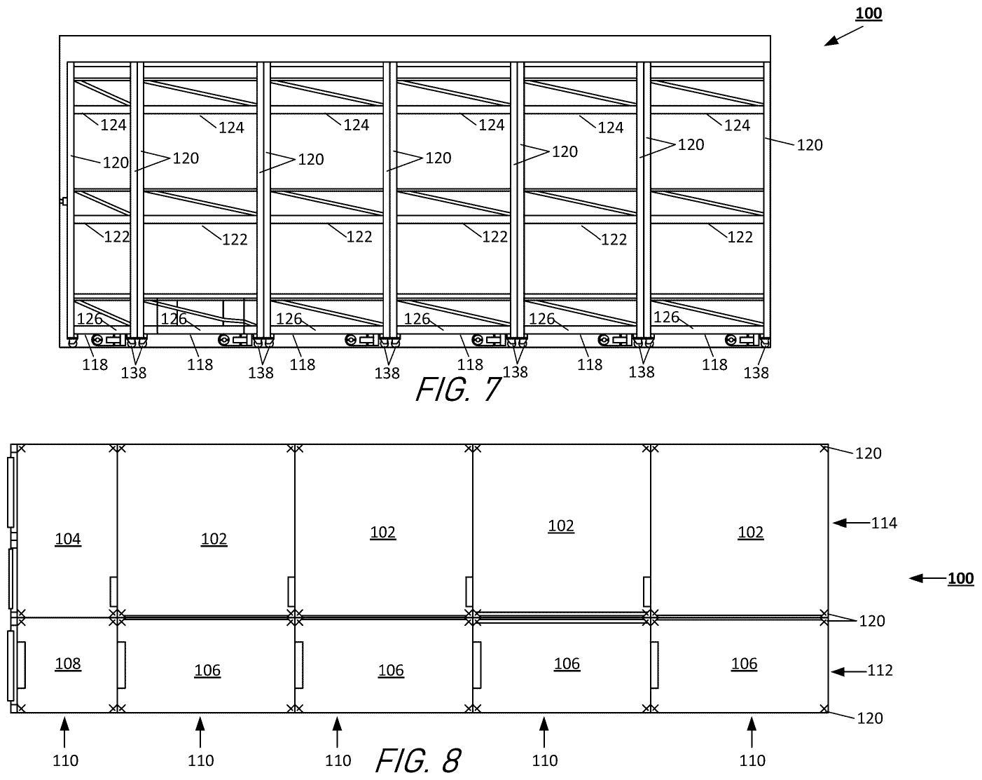

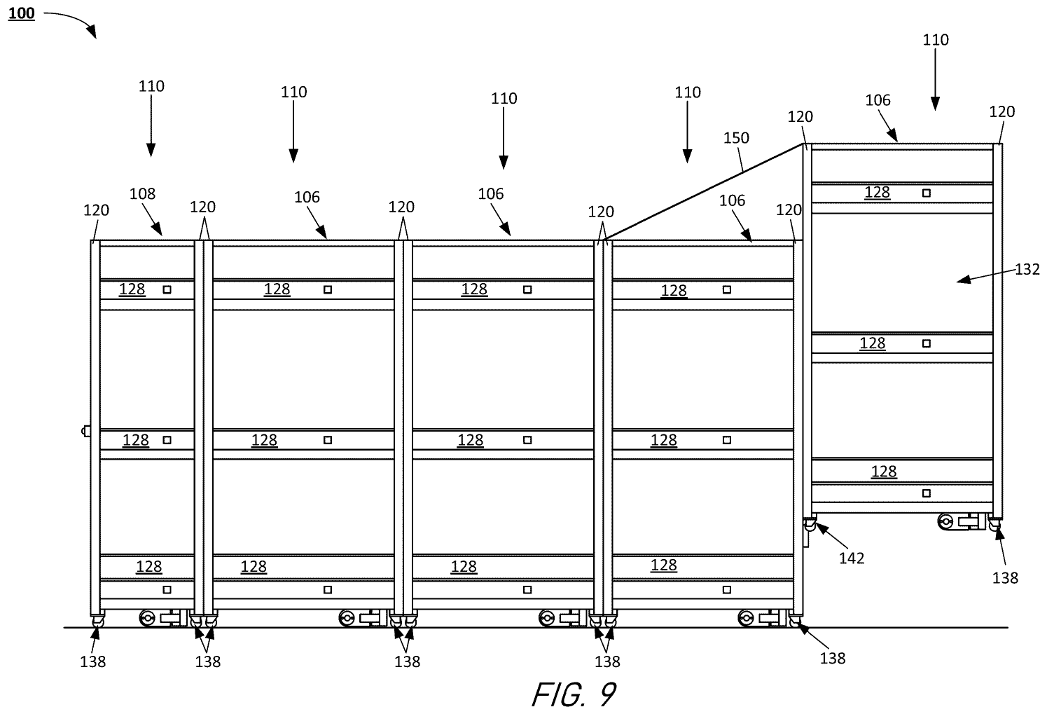

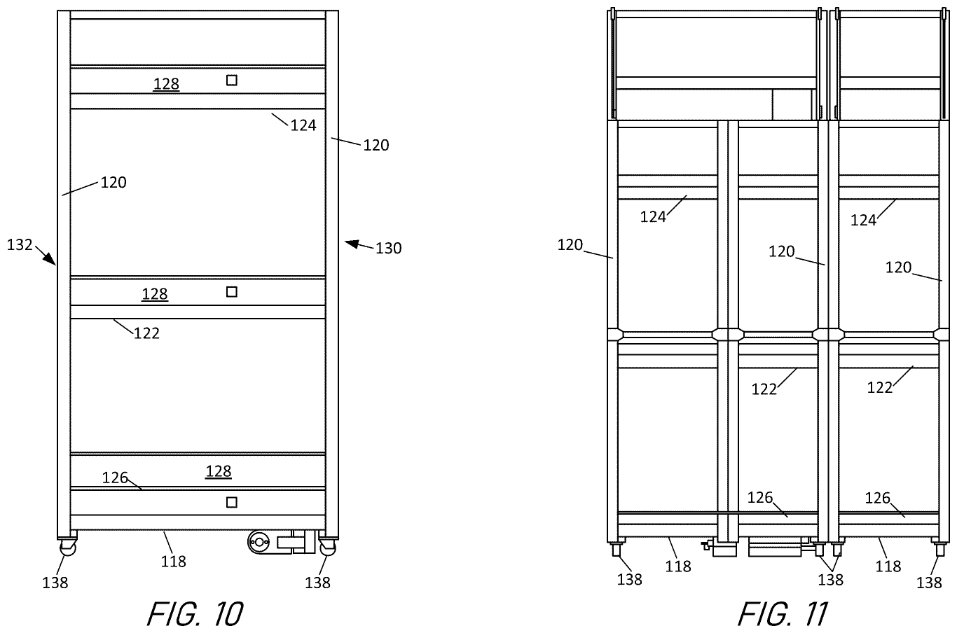

Turning now to FIGS. 7-11, there are shown varying views of the unitized storage assembly 100 in accordance with some aspects contemplated herein. In particular, FIGS. 7-11 provide illustrations of the unloaded unitized storage assembly 100 utilizing the components described above with respect to FIGS. 1-6. Accordingly, FIG. 7 provides a side view of the unloaded unitized storage assembly 100 and FIG. 8 provides a top view of the unitized storage assembly 100. FIG. 9 provides a side view of the unitized storage assembly 100, wherein a first row 110 has been raised via the elevating mechanism 142 to a predetermined height, e.g., the height of the floor of the cargo space 115 relative to ground level. As shown in FIG. 9, the elevated first row 110 remains movably secured to the adjacent row 110 via straps 150. It will be appreciated that in the example of FIGS. 7-11, the straps 150 may function as security or safety straps to ensure that rows 110 remain secured to each other when being raised and lowered. FIG. 10 provides a side view of a storage unit 102-108, whereas FIG. 11 provides view of a front side of the unitized storage assembly 100 in accordance with some aspects contemplated herein.

Various components of the unitized storage assembly 100 and/or the individual storage units 102-108 which make up the unitized storage assembly 100 may be accessed and interacted with based on instructions received from one or more computing devices in the form of one or more controllers that may be included as part of the assembly 100. According to some aspects disclosed herein, these components may also be operated responsive to instructions that are wirelessly received from one or more computing devices that are external to the unitized storage assembly 100. For example, the various components within the unitized storage assembly 100 may operate based on instructions received from, e.g., devices in the form of smartphones, laptops, tablets, iPads, and various other computing devices that are capable of transmitting and receiving instructions wirelessly.

Operation of the unitized storage assembly 100 may be aided by one or more sensors, such as proximity, position, limit switches, and/or image sensors, for example. These sensors may be embedded or otherwise mounted to the individual storage units 102-108 and/or the associated vehicle 116 to provide data that assists the automated loading process. More particularly, the one or more controllers may receive and/or send instructions based at least in part on sensor data to cause the motor to activate the wheels of one or more storage units in the plurality. The one or more controllers may also receive and/or send instructions based at least in part on sensor data to cause the elevating mechanism 142 of a storage unit 102-108 to activate, thereby lifting an adjacent storage unit 102-108 to a specified height.

The unitized storage assembly 100 may include one or more power sources to provide electricity to the various components of the unitized storage assembly 100, such as wheel motor(s) 140, the one or more elevating mechanisms 142, the one or more computing devices, and the one or more sensors, for example. The one or more power sources may be an AC power source or a DC power source. A single power source may be used to power an entire plurality of storage units 102-108, or individual storage units 102-108 in the plurality may each be provided with a discrete power source.

Example operations of the unitized storage assembly 100 for automated loading in an associated vehicle 116 may be better understood in conjunction with the images shown in FIGS. 12-17. As shown in FIG. 12, the individual storage units 102-108 are initially loaded with packages 144, e.g., boxes, items, etc., on one or shelves 122-126. In the example of FIGS. 12-17, a plurality of individual storage units 102-108 are shown assembled into the unitized storage assembly 100. According to some aspects contemplated herein, the joining, i.e., assembling, of the individual storage units 102-108 to form the unitized storage assembly 100. In such an aspect, a controller may be used to instruct individual storage units 102-108 to assemble into a specified row 110 and/or column 112-114 and thereby form multiple block configurations ready for automated loading into an associated vehicle 116. Each block configuration of storage units 102-108 may be assigned to a particular vehicle 116 having a specific delivery route.

After loading and assembly of the individual storage units 102-108, the unitized storage assembly 100 is moved to a staging area adjacent to the cargo space 115 of an assigned vehicle 116, as shown in FIG. 12. Alternatively, it will be appreciated that the associated vehicle 116 may be maneuvered into the staging area for loading of the unitized storage assembly 100. The moving of each block of storage units 102-108 to the staging area may be automated. That is, the controller may be used to activate the wheel motor(s) 140 of the unitized storage assembly 100 of storage units 102-108 such that the assembly 100 is moved into the staging area. In the staging area, a centerline of the unitized storage assembly 100 of storage units 102-108 is aligned with a centerline of the associated vehicle 116.

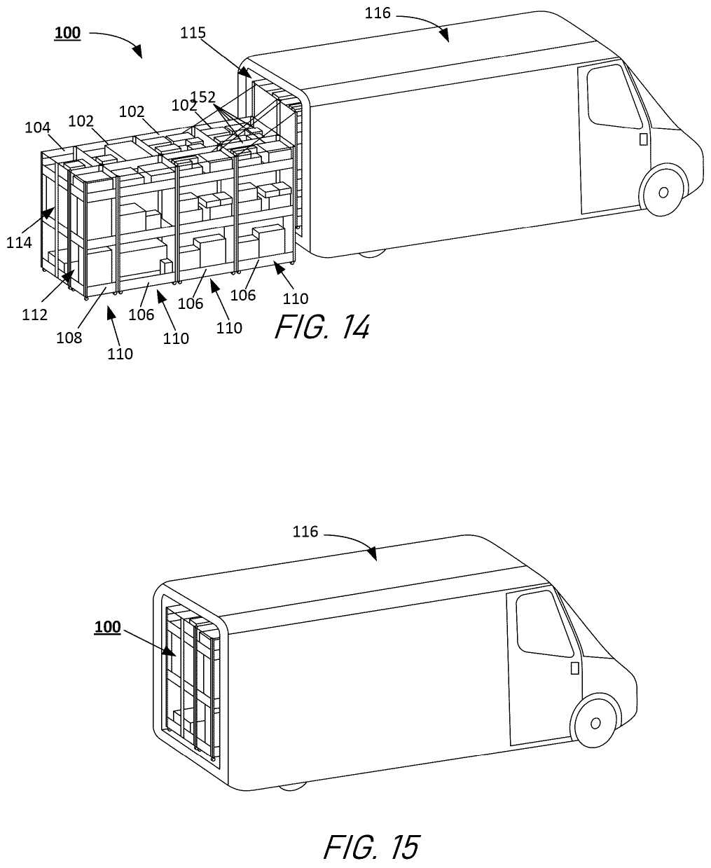

Once the unitized storage assembly 100 is moved to the staging area and is properly aligned with the associated vehicle 116, the automated loading process can begin by raising the first row 110 of storage units 102-108 to a specified height, as shown in FIG. 13. That is, the controller may be used to instruct the elevating mechanism 142 disposed between the first and second row 110 of storage units 102-108 to activate until the specified height is reached. The specified height is generally equal to the height of the cargo space 115 loading floor, which may be automatically determined using one or more sensors. Once the row 110 of storage units 102-108 is raised to the to the height of the cargo space 115 loading floor, the unitized storage assembly 100 advances forward into the vehicle front-rear direction until the first row 110 of storage units 102-108 is disposed within the cargo space, as shown in FIG. 14.

That is, the controller may be used to instruct the wheel motor(s) 140 to activate, thereby causing the wheels 138 of the storage units 102-108 to rotate and move the unitized storage assembly 100 forward. One or more sensors may be used to automatically determine when the first row 100 of storage units 102-108 has been received within the cargo space 115. Once the first row 110 of storage units 102-108 is moved into position within the cargo space 115, the elevating mechanism 142 disposed between the first and second rows 110 of storage units 102-108 may be instructed to disengage such that the weight of the first row 110 of storage units 102-108 can be supported by the loading floor of the associated vehicle 116. This process of raising a row 110 of storage units 102-108 and advancing the raised row 110 into the cargo space 115 of the associated vehicle 116 is repeated for each row 110 in the unitized storage assembly 100 until the entire assembly 100 has been loaded into the cargo space 115, as illustrated in FIG. 15.

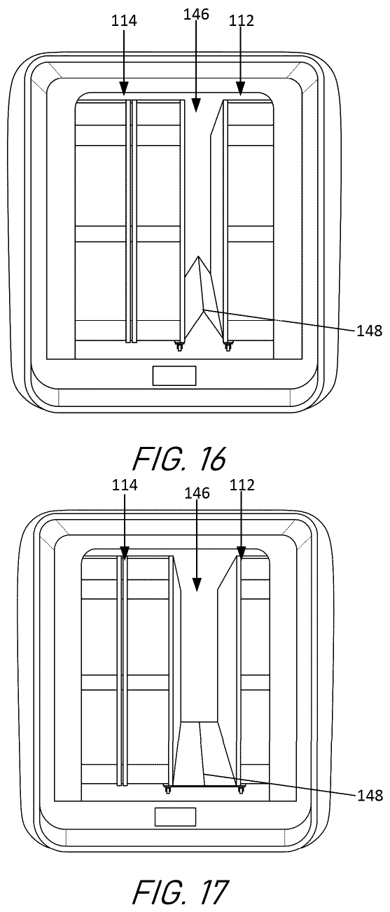

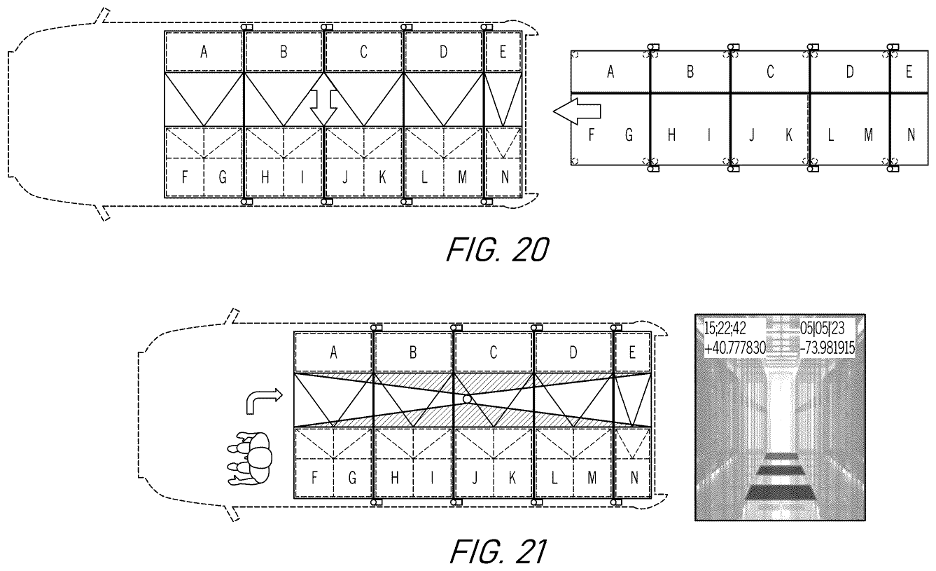

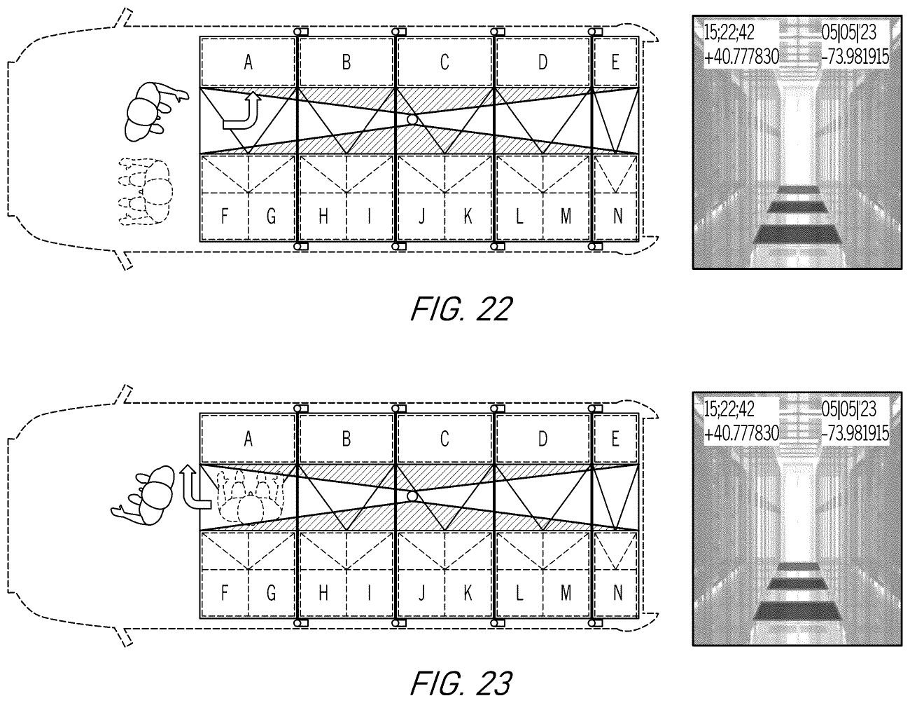

With reference now to FIGS. 16 and 17, there are shown images of the cargo space 115 of the associated vehicle 116 after the entire unitized storage assembly 100 has been loaded. Thereafter, while within the cargo space 115 of the associated vehicle 116, an automated separation and locking process can begin to create an aisle 146 between the columns 112-114 of the storage units 102-108. FIGS. 20-23 provide illustrative top views of the unitized storage assembly 100 loaded onto the associated vehicle 116 prior to, during, and after expansion to provide the aisle 146 between columns 112 and 114 in accordance with some aspects.

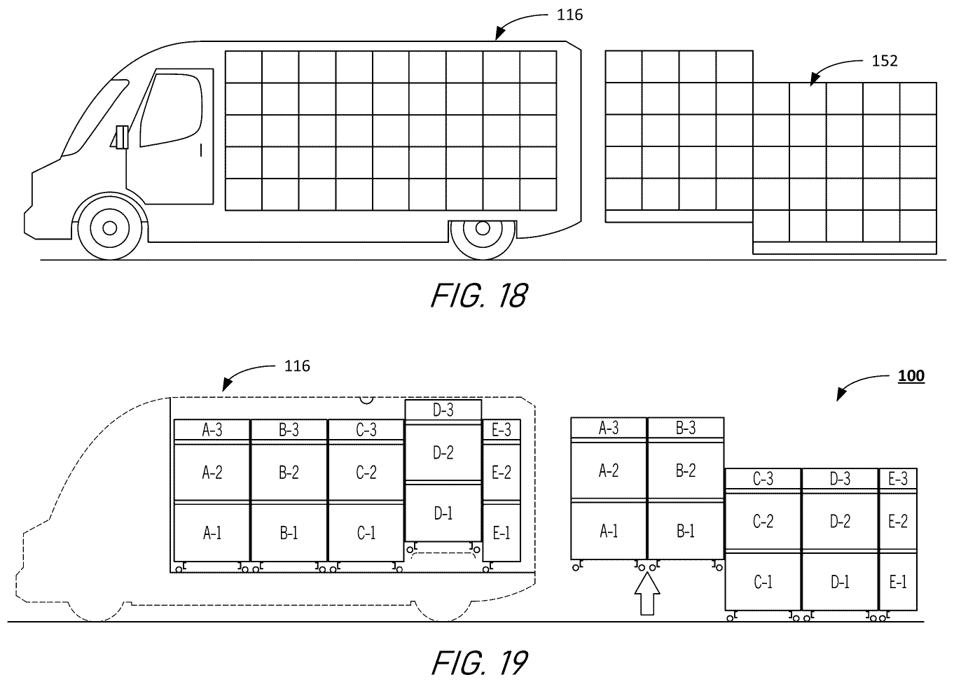

As shown in FIGS. 16 and 17, the separation process begins by first rotating the wheels 138 of the storage units 102-108 90 degrees such that upon activation, the wheels 138 are positioned to move in a direction parallel to the vehicle width direction. That is, the controller is used to instruct the wheels 138 to rotate and move outward in the vehicle width direction such that the first column 112 of storage units 106-108 moves toward the right side wall of the vehicle cargo space 116 and the second column 114 of storage units 102-104 moves toward the left side wall of the vehicle cargo space 115. One or more sensors may be used to inform the controller how far each column 112-114 should move toward the respective right and left side walls of the vehicle cargo space 115. Once fully separated, an aisle 146 is created between the two columns 112-114 of storage units 102-108 which provides enough room for a user (e.g., delivery driver) to perform necessary tasks within the cargo space 115. In some embodiments, a folding floor 148 may be disposed between the inner side faces 136 of each column 112-114 of storage units 102-108 which unfolds during the column separation process and locks the columns 112-114 into place. FIGS. 18-19 provide illustrative examples of configurations of the unitized storage assembly 100 loaded within an associated vehicle 116. As shown in FIG. 18, the unitized storage assembly 100 is configured in equal-sized units 152, whereas FIG. 19 provides an illustration of the unitized storage assembly 100 described above with respect to FIGS. 12-17.

The systems and processes for automated loading of an associated vehicle 116, as described in the above examples, present numerous advantages over existing manual loading techniques. For example, the time it takes to load the cargo space of the vehicle is improved since the automated loading process can be completed in approximately 90 seconds for a standard size delivery vehicle, whereas traditional manual loading may take at least 15 minutes. Furthermore, the redundant handling of packages is eliminated since a user is no longer required to manually load the vehicle package by package. Moreover, by eliminating redundant handling of packages, unsafe loading movements are reduced. In addition, resource waste (e.g., human resources, disposable totes, cardboard boxes, idle time) is reduced.

In accordance with various aspects disclosed herein, it will be appreciated that the unitized storage assembly 100, as described above, is capable of a variety of different movements. Further, while actuation is shown generally in two planes (vertical and horizontal) and two types (linear and radial (horizontal pivot)), these movements are illustrative as to show the range of movement “transformation” options enabled by the joinery described above. However, it will be understood that unitized storage assembly 100 and individual storage units 102-108 permit other movement actuation which result in the physical transformation of the unitized assembly 100. Such movements include but are not limited to: radial vertical pivot, radial turning pivot (rotational), bi-directional simultaneous actuation, autonomous horizontal, autonomous radial, autonomous pivoting, and autonomous vertical.

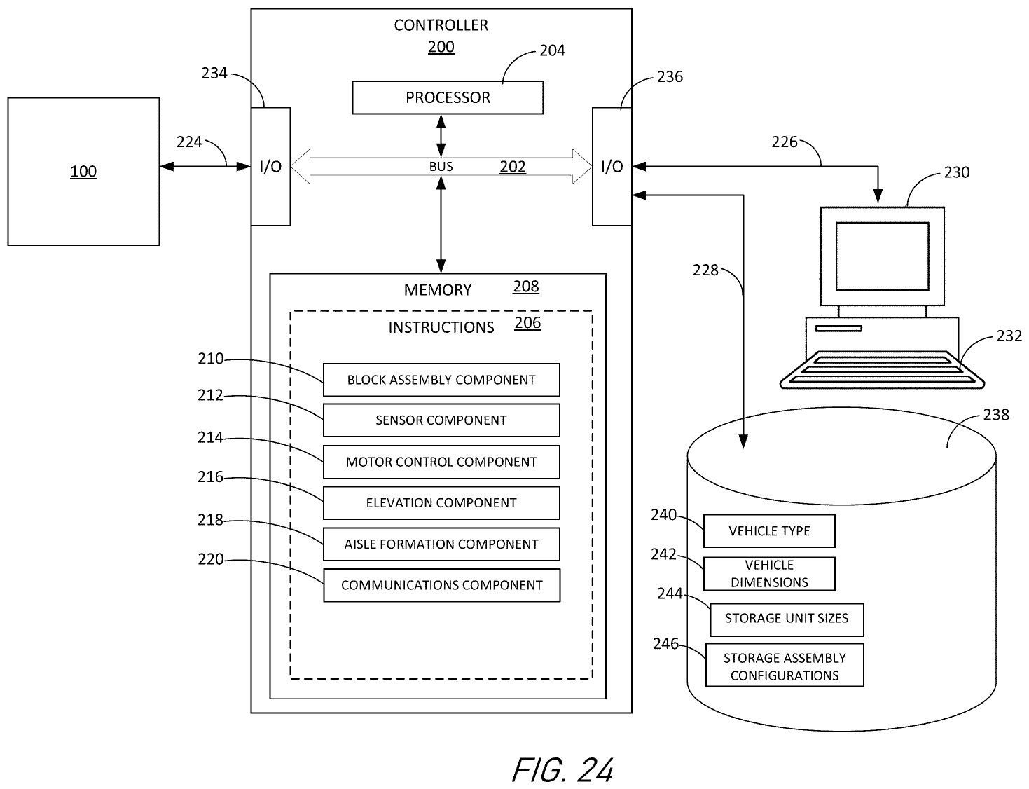

As noted above, operations of the unitized storage assembly 100 may be accomplished in accordance with direction from one or more controllers 200. Turning now to FIG. 24, there is shown an example diagram of such a controller 200 in accordance with some aspects contemplated herein. It will be appreciated that while reference is made hereinafter to actions and operations of the unitized storage assembly 100, the controller 200 as described below is operative control operations of any of the rows 110, columns 112-114 and/or individual storage units 102-108 described above, and the discussion with respect to the unitized storage assembly 100 is not intended as limiting such operations. As shown in FIG. 24, the controller 200, which is capable of implementing the methods set forth herein, includes a processor 204, which performs an example method by execution of processing instructions 206 that are stored in memory 208 connected to the processor 204, as well as controlling the overall operations of the unitized storage assembly 100. The various components of the controller 200 may be connected by a data/control bus 202. The processor 204 of the controller 200 may be in communication with an associated database 238 via a suitable communications link 228. A suitable communications link 228 may include, for example, a switched telephone network, a wireless radio communications network, infrared, optical, or other suitable wired or wireless data communications. The database 238 is capable of implementation on components of the controller 200, e.g., stored in local memory 208, e.g., on hard drives, virtual drives, or the like, or on remote memory accessible to the controller 200. It will be appreciated that while depicted in FIG. 24 as a single device, the controller 200 may be representative of a cloud-based computing, e.g., distributed processing system, and the illustration of the controller 200 as a single device is intended solely as a non-limiting illustrative example.

The associated database 238 is representative of any organized collections of data (e.g., vehicle type 240, vehicle dimensions 242, storage unit sizes 244, storage assembly configurations 246, etc.) used for one or more purposes. The skilled artisan will appreciate that such information may be updated via machine learning during operations of the subject system. Implementation of the associated database 238 is capable of occurring on any mass storage device(s), for example, magnetic storage drives, a hard disk drive, optical storage devices, flash memory devices, or a suitable combination thereof. The associated database 238 may be implemented as a component of the controller 200, e.g., resident in memory 208, or the like. In one embodiment, the associated database 238 may include data corresponding to pre-planned storage unit configurations, vehicle heights, vehicle orientations, vehicle widths, vehicle weight limits, vehicle routes, etc.

The controller 200 may include one or more input/output (I/O) interface devices 234 and 236 for communicating with external devices. The I/O interface 236 may communicate, via communications link 226, with one or more of a display device 230, for displaying information, possible cleaning programs, start/stop times, etc., and a user input device 232, such as a keyboard or touch or writable screen, for inputting text, and/or a cursor control device, such as mouse, trackball, or the like, for communicating user input information and command selections to the processor 204. The I/O interface 234 may communicate with external devices such as a user device (e.g., a mobile communications device, IoT device, and the like), via a suitable the communications link 224. In some aspects contemplated herein, the display device 230 and the user input device 232 may be combined into a single device, e.g., a smart phone, tablet, etc. The I/O interface 234 may be implemented as a suitable transceiver capable of establishing bi-directional communication with external devices. In such aspects, the communications link 224 may be implemented as a near-field or personal area network, e.g., BLUETOOTH or other suitable short-range wireless technology standard. In other aspects, such a communications link 224 may be an infra-red or near infra-red wireless communication link.

It will be appreciated that the controller 200 illustrated in FIG. 24 is capable of implementation using a distributed computing environment, such as a computer network, which is representative of any distributed communications system capable of enabling the exchange of data between two or more electronic devices. It will be further appreciated that such a computer network includes, for example and without limitation, a virtual local area network, a wide area network, a personal area network, a local area network, the Internet, an intranet, or any suitable combination thereof. Accordingly, such a computer network comprises physical layers and transport layers, as illustrated by various conventional data transport mechanisms, such as, for example and without limitation, Token-Ring, Ethernet, or other wireless or wire-based data communication mechanisms. Furthermore, while depicted in FIG. 24 as a networked set of components, the controller 200 is capable of implementation on a stand-alone device.

The controller 200 may include one or more of a computer server, workstation, personal computer, cellular telephone, tablet computer, pager, combination thereof, or other computing device capable of executing instructions for performing the exemplary method. According to one example embodiment, the controller 200 includes hardware, software, and/or any suitable combination thereof, configured to interact with an associated user, a networked device, networked storage, remote devices, or the like.

The memory 208 illustrated in FIG. 24 as a component of the controller 200 may represent any type of non-transitory computer readable medium such as random access memory (RAM), read only memory (ROM), magnetic disk or tape, optical disk, flash memory, or holographic memory. In one embodiment, the memory 208 comprises a combination of random access memory and read only memory. In some embodiments, the processor 204 and memory 208 may be combined in a single chip. The network interface(s) 234, 236 allow the computer to communicate with other devices via a computer network, (e.g., the Internet), and may comprise a modulator/demodulator (MODEM). Memory 208 may store data processed in the method as well as the instructions for performing the exemplary method.

The processor 204 can be variously embodied, such as by a single core processor, a dual core processor (or more generally by a multiple core processor), a digital processor and cooperating math coprocessor, a digital controller, or the like. The processor 204, in addition to controlling the operation of the controller 200, executes instructions 206 stored in memory 208 for performing the method set forth hereinafter.

As shown in FIG. 24, the instructions 206 stored in memory 208 may include a block assembly component 210, configured to assemble the individual storage units 102-108 into a specific row 110 and/or column 112-114, thereby forming multiple block configurations (e.g., unitized storage assemblies 100) for automated loading into an associated vehicle 116. In some aspects, the block assembly component 210 may be configured to identify various individual storage units 102-108 to be combined into an assembly 100.

The instructions 206 stored in memory 208 may further include a sensor component 212 that is configured to receive sensor input from one or more sensors associated with the individual storage units 102-108, the unitized storage assembly 100, the associated vehicle 116, or the like. For example, one or more sensors may be configured to send position data, identification data, elevation data, orientation data, block configuration information, or the like.

Additionally, the instructions 206 in memory 208 may also include a motor control component 214, which is configured to control activation, speed, rotation, etc., of the wheels 138 to effectuate movement of the individual storage units 102-108 and/or the unitized storage assembly 100. In some aspects, the motor control component 214 may be configured to direct the wheels 138 to move the assembly 100 into a particular location or position relative to the associated vehicle 116, loading dock, stocking location, or the like. In accordance with some aspects contemplated herein, the motor control component 214 may operate in conjunction with the sensor component 212 to enable proper positioning of the assembly 100, the individual units 102-108, or the like.

The instructions 206 stored in memory 208 may further include an elevation control component 216 configured to activate and/or deactivate the elevating mechanism 142. In some aspects, the elevating control component 216 may be in communication with the sensor component 212, such that upon a signal or other data received from one or more sensors indicating that the assembly 100 is in the correct position relative to the vehicle 116, the elevating component 216 activates the elevating mechanism 142 to raise a row 110 to a height corresponding to the cargo space 115 of the associated vehicle 116.

The instructions 206 stored in memory 208 further include an aisle formation component 218 configured to interact with the motor control component 214 and sensor component 212 to separate the columns 112 and 114 of the assembly 100 after loading into the cargo space 115. The aisle formation component 218 may be further configured to establish the aisle 146 in accordance with the dimensions of the vehicle 116 stored in the database 238.

In some embodiments, the controller 212 may include instructions 206 stored in memory 208 that include a communications component 220. In such embodiments, the communications component 220 may be configured to communicate with one or more external, e.g., remote devices, receive instructions from such remote devices, and the like. According to some aspects, a mobile device (not shown) running an app may remotely control operations of the unitized storage assembly 100. For example, a user may, via the mobile device, send a remote command to the controller 200 via a computer network or other communications medium indicating that operations of the unitized storage assembly 100 to begin a preprogrammed route for formation of the assembly 100, movement for loading/unloading of products, movement to or from a vehicle 116, and the like. The communications component 220 receives this information, and in conjunction with the other components 210-218 described above, facilitates operations of the individual units 102-108 and/or the unitized storage assembly 100.

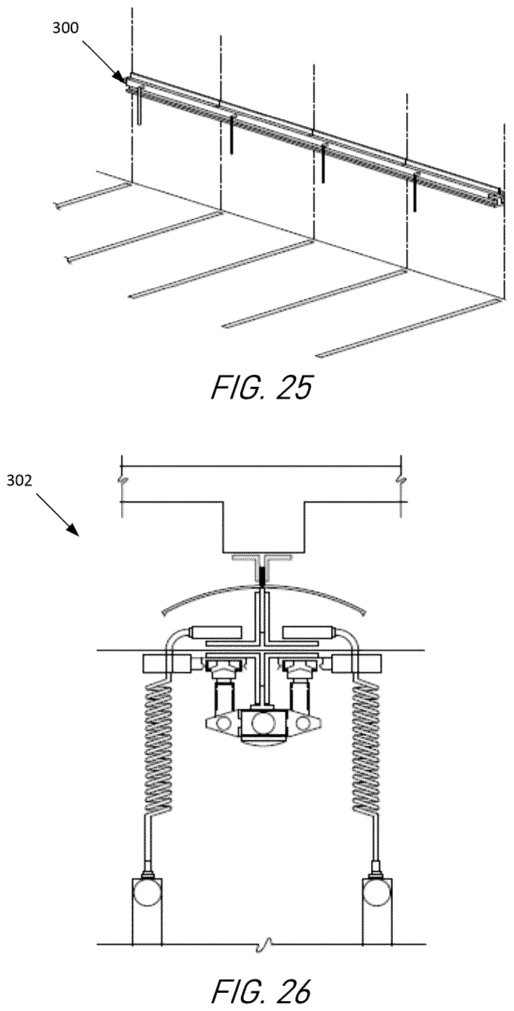

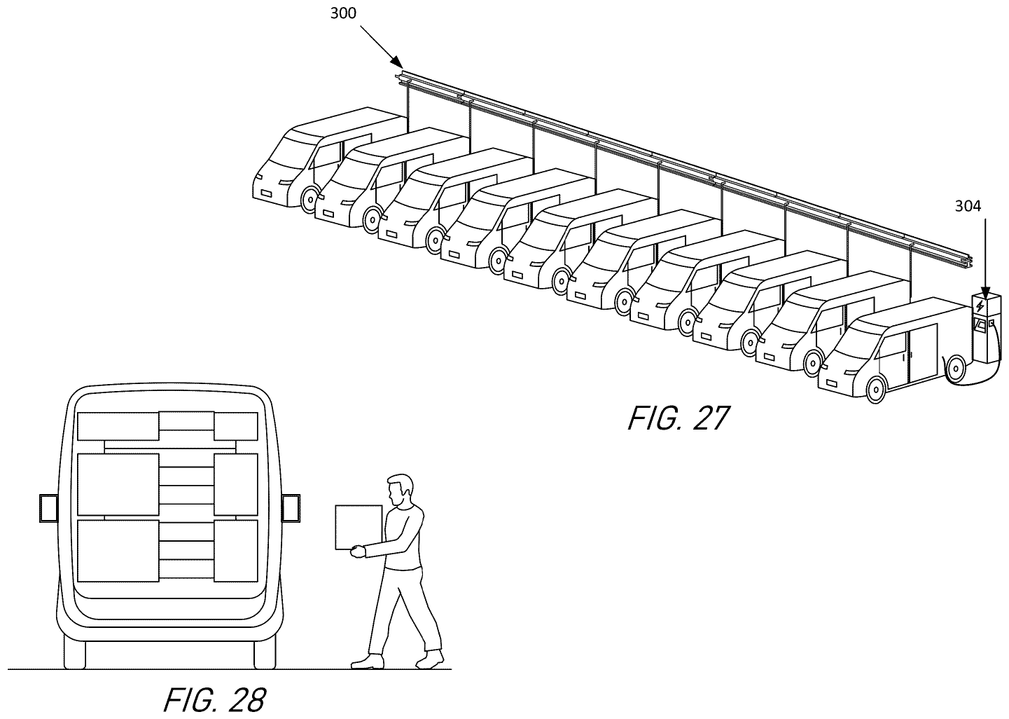

The systems and processes for automated loading discussed above are described in connection with an associated vehicle 116, and the associated vehicle may be an electric vehicle belonging to a fleet of electric vehicles. Referring now to FIGS. 25-28 below, a smart charging assembly 300-304 for one or more electric vehicles in a fleet is shown in accordance with embodiments of the present disclosure. The smart charging assembly 300-304 provides a high-density, low power charging solution that delivers the ability to effectively charge a fleet by increasing the capacity of a charge point by at least a factor of 10.

The assembly includes an elongated rail 300, as illustrated in FIG. 25, and a universal charging mechanism or rig 302, as illustrated in FIG. 26. In some embodiments, the elongated rail 300 is made up of a plurality of rail units that are interconnected to form a unitized rail assembly which utilizes the universal joinery described above. In some embodiments, the charging mechanism 302 includes at least one charging port which can be inserted into and/or paired to a charging receiver/receptacle of the electric vehicle 116. In other embodiments, the elongated rail 300 can include a plurality of charging ports. The charging mechanism 302 is configured to travel along at least a portion of the elongated rail 300 and establish an electro-mechanical connection at various points along the rail from which one or more electric vehicles located adjacent to the connection point can be charged, as illustrated in FIG. 27. In this regard, the elongated rail 300 is electrically powered by a charging station 304. In some embodiments, the charging station 304 may be a level 2 charging station. In other embodiments, the charging station is a level 3 charging station also known as a direct current fast charger (DCFC). In additional embodiments, the charging station provides both level 2 and level 3 charging.

As each electric vehicle 116 in the fleet returns to its point of origin, such as a warehouse or other location, each of the one or more electric vehicles may be parked in a designated charging area where access to the elongated rail 300 and charging mechanism 302 is provided. Once parked in the designated area, one or more sensors may inform the charging mechanism 302 and/or the charging station 304 that a vehicle 116 is parked and ready for charging. For example, and in embodiments, the one or more sensors may be configured to sense a position of the at least one electric vehicle 116 relative to the elongated rail. Without being limited by theory, the information built into the position may comprise a longitudinal distance of the at least one electric vehicle 116 away from the elongated rail 300 as well as a lateral distance of the at least one electric vehicle 116 along the length of the elongated rail 300. In at least one embodiment, the one or more sensors may comprise a plurality of load cells arranged in a matrix such that the position(s) of the electric vehicle(s) 116 may be determined by which load cells in the matrix are experiencing a threshold load.

The one or more sensors may also be configured to transmit the position to the charging station 304, i.e. the one or more sensors may be communicatively coupled (either directly or wirelessly) to at least the charging station 304, but also any other component of the assembly. Further, the charging station 304 may be further configured to receive the position from the one or more sensors as well as to generate a command to the at least one charging mechanism upon determining the position of the at least one electric vehicle 116 is within a threshold proximity to the at least one charging mechanism 302 and the at least one charging port (i.e. at least one of the charging ports can reach the charging receiver/receptacle of the electric vehicle 116). Further yet, the at least one charging mechanism 302, upon receiving the command, may be configured to travel along the elongated rail 300 to the at least one electric vehicle to provide power from the charging station 304 to the parked vehicle 116. In embodiments where the charging mechanism 302 includes at least one charging port, the at least one charging port can then be inserted into the corresponding receiver/receptacle on the electric vehicle to begin charging the vehicle.

In embodiments where the elongated rail 300 includes a plurality of charging ports, one of the charging ports from the rail 300 can be inserted into the corresponding receiver/receptacle on the electric vehicle once the vehicle is parked. The charging mechanism 302 may then automatically travels along the rail to the corresponding connection point to thereby provide power from the charging station 304 and begin charging the electric vehicle 116.

Implementation examples are described in the following numbered clauses:

Clause 1: A unitized storage assembly for automated loading and unloading of an associated cargo space, comprising: a plurality of individual storage units positioned in a plurality of rows, wherein each row comprises an opposing pair of individual storage units and wherein each row is movably coupled to an adjacent row; an elevating mechanism coupled to at least one of the pair of individual storage units of one of the plurality of rows, the elevating mechanism operative to move the one of the plurality of rows in at least one of a vertical or horizontal direction relative to the adjacent row; a motor operatively coupled to at least one wheel rotatably mounted on a bottom surface of a base of at least one of the plurality of individual storage units; and a controller in data communication with the elevating mechanism and the motor, the controller comprising a processor in communication memory storing instructions which are executed by the processor to: activate the elevating mechanism to raise the at least one of the pair of individual storage units of one of the plurality of rows a predetermined height, and activate the motor to rotate the at least one wheel to move the unitized storage assembly in at least one direction.

Clause 2: The unitized storage assembly of clause 1, wherein each of the plurality of individual storage units further comprises at least one universal post extending vertically upward from the base.

Clause 3: The unitized storage assembly of clause 2, wherein each of the plurality of individual storage units further comprises at least one shelf horizontally supported by the at least one universal posts.

Clause 4: The unitized storage assembly of clause 3, wherein each individual storage unit further comprises a front face, a rear face opposing the front face, an outer side face and an inner side face opposing the outer side face.

Clause 5: The unitized storage assembly of clause 4, wherein the inner side face of a first individual storage unit of the pair of individual storage units is aligned with the inner side face of a second individual storage unit of the pair of individual storage units.

Clause 6: The unitized storage assembly of clause 5, wherein the at least one universal post of the first individual storage unit abuts the at least one universal post of the second individual storage unit.

Clause 7: The unitized storage assembly of clause 6, wherein each inner side face of the first and second individual storage units further include at least one respective engagement feature, and wherein when the inner side faces of the first and second individual storage units are aligned and abut together, the at least one respective engagement features engage one another and lock the inner side faces of the first and second individual storage units into alignment.

Clause 8: The unitized storage assembly of clause 7, wherein the at least one elevating mechanism is disposed on at least one of the rear face, on the at least one universal post, adjacent to the front face, or the outer side face.

Clause 9: The unitized storage assembly of clause 8, wherein the at least one elevating mechanism comprises at least one of a hydraulic linear actuator, a pneumatic linear actuator, a mechanical linear actuator, or an electro-mechanical linear actuator.

Clause 10: The unitized storage assembly of clause 7, wherein a plurality of adjacent first individual storage units comprise a first column and a plurality of adjacent second individual storage units comprise a second column opposing the first column.

Clause 11: The unitized storage assembly of clause 10, further comprising a folding floor disposed between the first and second opposing columns of the unitized storage assembly.

Clause 12: The unitized storage assembly of clause 10, further comprising instructions to unfold the folding floor between the first and second opposing columns to form an aisle therebetween.

Clause 13: The unitized storage assembly of clause 12, wherein the associated cargo space comprises at least one of a shipping container, a vehicle, a truck, a van, a passenger vehicle, a heavy goods vehicle (HGV, box, etc.), an electric vehicle (EV), an EV quad vehicle, a robotic vehicle, a cargo plane, a railcar, or a sea-based cargo container.

Clause 14: The unitized storage assembly of clause 7, wherein the first individual storage container has a volume greater than the second individual storage container.

Clause 15: A method of loading and unloading a cargo space of an associated vehicle using the unitized storage assembly of any of clauses 1-14 comprising: raising an initial row of the plurality of rows to the predetermined height via the elevating mechanism; activating the motor to rotate the at least one wheel to move the unitized assembly in a direction toward the cargo space of the associated vehicle; lowering the initial row of the plurality of rows to a floor of the cargo space; raising at least one subsequent row of the plurality of rows to the predetermined height, the at least one subsequent row movably coupled to the initial row; activating the motor to rotate the at least one wheel to move the unitized assembly in the direction toward the cargo space of the associated vehicle, wherein the initial row and the at least one subsequent row of the assembly are inside the cargo space; lowering, via the elevating mechanism, the at least one subsequent row of the plurality of rows to the floor of the cargo space.

Clause 16: An electric vehicle charging assembly comprising: an elongated rail; at least one charging mechanism configured to travel along at least a portion of the rail, the at least one charging mechanism comprising at least one charging port configured to pair to a charging receiver or receptacle of at least one electric vehicle; and a charging station configured to electrically power the elongated rail, and thereby the at least one charging mechanism.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular aspects have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A unitized storage assembly for automated loading and unloading of an associated cargo space, comprising:
a plurality of individual storage units positioned in a plurality of rows, wherein each row comprises an opposing pair of individual storage units and wherein each row is movably coupled to an adjacent row;
an elevating mechanism coupled to at least one of the pair of individual storage units of one of the plurality of rows, the elevating mechanism operative to move the one of the plurality of rows in at least one of a vertical or horizontal direction relative to the adjacent row;
a motor operatively coupled to at least one wheel rotatably mounted on a bottom surface of a base of at least one of the plurality of individual storage units; and
a controller in data communication with the elevating mechanism and the motor, the controller comprising a processor in communication memory storing instructions which are executed by the processor to:
activate the elevating mechanism to raise the at least one of the pair of individual storage units of one of the plurality of rows a predetermined height, and
activate the motor to rotate the at least one wheel to move the unitized storage assembly in at least one direction.

2. The unitized storage assembly of claim 1, wherein each of the plurality of individual storage units further comprises at least one universal post extending vertically upward from the base.

3. The unitized storage assembly of claim 2, wherein each of the plurality of individual storage units further comprises at least one shelf horizontally supported by the at least one universal posts.

4. The unitized storage assembly of claim 3, wherein each individual storage unit further comprises a front face, a rear face opposing the front face, an outer side face and an inner side face opposing the outer side face.

5. The unitized storage assembly of claim 4, wherein the inner side face of a first individual storage unit of the pair of individual storage units is aligned with the inner side face of a second individual storage unit of the pair of individual storage units.

6. The unitized storage assembly of claim 5, wherein the at least one universal post of the first individual storage unit abuts the at least one universal post of the second individual storage unit.

7. The unitized storage assembly of claim 6, wherein each inner side face of the first and second individual storage units further include at least one respective engagement feature, and wherein when the inner side faces of the first and second individual storage units are aligned and abut together, the at least one respective engagement features engage one another and lock the inner side faces of the first and second individual storage units into alignment.

8. The unitized storage assembly of claim 7, wherein the at least one elevating mechanism is disposed on at least one of the rear face, on the at least one universal post, adjacent to the front face, or the outer side face.

9. The unitized storage assembly of claim 8, wherein the at least one elevating mechanism comprises at least one of a hydraulic linear actuator, a pneumatic linear actuator, a mechanical linear actuator, or an electro-mechanical linear actuator.

10. The unitized storage assembly of claim 7, wherein a plurality of adjacent first individual storage units comprise a first column and a plurality of adjacent second individual storage units comprise a second column opposing the first column.

11. The unitized storage assembly of claim 10, further comprising a folding floor disposed between the first and second opposing columns of the unitized storage assembly.

12. The unitized storage assembly of claim 10, further comprising instructions to unfold the folding floor between the first and second opposing columns to form an aisle therebetween.

13. The unitized storage assembly of claim 12, wherein the associated cargo space comprises at least one of a shipping container, a vehicle, a truck, a van, a passenger vehicle, a heavy goods vehicle (HGV, box, etc.), an electric vehicle (EV), an EV quad vehicle, a robotic vehicle, a cargo plane, a railcar, or a sea-based cargo container.

14. The unitized storage assembly of claim 7, wherein the first individual storage container has a volume greater than the second individual storage container.

15. A method of loading and unloading a cargo space of an associated vehicle using the unitized storage assembly of claim 1, comprising:
raising an initial row of the plurality of rows to the predetermined height via the elevating mechanism;
activating the motor to rotate the at least one wheel to move the unitized assembly in a direction toward the cargo space of the associated vehicle;
lowering the initial row of the plurality of rows to a floor of the cargo space;
raising at least one subsequent row of the plurality of rows to the predetermined height, the at least one subsequent row movably coupled to the initial row;
activating the motor to rotate the at least one wheel to move the unitized assembly in the direction toward the cargo space of the associated vehicle, wherein the initial row and the at least one subsequent row of the assembly are inside the cargo space;
lowering, via the elevating mechanism, the at least one subsequent row of the plurality of rows to the floor of the cargo space.

16. A method of loading and unloading a cargo space of an associated vehicle using the unitized storage assembly of claim 13, comprising:
raising an initial row of the plurality of rows to the predetermined height via the elevating mechanism;
activating the motor to rotate the at least one wheel to move the unitized assembly in a direction toward the cargo space of the associated vehicle;
lowering the initial row of the plurality of rows to a floor of the cargo space;
raising at least one subsequent row of the plurality of rows to the predetermined height, the at least one subsequent row movably coupled to the initial row;
activating the motor to rotate the at least one wheel to move the unitized assembly in the direction toward the cargo space of the associated vehicle, wherein the initial row and the at least one subsequent row of the assembly are inside the cargo space;
lowering, via the elevating mechanism, the at least one subsequent row of the plurality of rows to the floor of the cargo space.

17. An electric vehicle charging assembly comprising:
an elongated rail;
at least one charging mechanism configured to travel along at least a portion of the rail, the at least one charging mechanism comprising at least one charging port configured to pair to a charging receiver or receptacle of at least one electric vehicle; and
a charging station configured to electrically power the elongated rail, and thereby the at least one charging mechanism.

18. A unitized storage assembly for automated loading and unloading of an associated cargo space, comprising:
a plurality of individual storage units positioned in a plurality of rows, wherein each row comprises an opposing pair of individual storage units and wherein each row is movably coupled to an adjacent row;
an elevating mechanism coupled to at least one of the pair of individual storage units of one of the plurality of rows, the elevating mechanism operative to move the one of the plurality of rows in both a vertical and horizontal direction relative to the adjacent row, and wherein the vertical and horizontal direction of movements also comprise vertical pivoting, rotational pivoting, or bi-directional combinations thereof;
a motor operatively coupled to at least one wheel rotatably mounted on a bottom surface of a base of at least one of the plurality of individual storage units; and
a controller in data communication with the elevating mechanism and the motor, the controller comprising a processor in communication memory storing instructions which are executed by the processor to:
activate the elevating mechanism to raise the at least one of the pair of individual storage units of one of the plurality of rows a predetermined height, and
activate the motor to rotate the at least one wheel to move the unitized storage assembly in at least one direction.

19. The unitized storage assembly of claim 18, wherein the associated cargo space comprises at least one of a shipping container, a vehicle, a truck, a van, a passenger vehicle, a heavy goods vehicle (HGV, box, etc.), an electric vehicle (EV), an EV quad vehicle, a robotic vehicle, a cargo plane, a railcar, or a sea-based cargo container.

20. A method of loading and unloading a cargo space of an associated vehicle using the unitized storage assembly of claim 18, comprising:
raising an initial row of the plurality of rows to the predetermined height via the elevating mechanism;
activating the motor to rotate the at least one wheel to move the unitized assembly in a direction toward the cargo space of the associated vehicle;
lowering the initial row of the plurality of rows to a floor of the cargo space;
raising at least one subsequent row of the plurality of rows to the predetermined height, the at least one subsequent row movably coupled to the initial row;
activating the motor to rotate the at least one wheel to move the unitized assembly in the direction toward the cargo space of the associated vehicle, wherein the initial row and the at least one subsequent row of the assembly are inside the cargo space;
lowering, via the elevating mechanism, the at least one subsequent row of the plurality of rows to the floor of the cargo space.
